(19) United States
(12) Patent Application Publication
(10) Pub. No.: US 2021/0160162 A1
(43) Pub. Date: May 27, 2021

(54) METHOD AND APPARATUS FOR ESTIMATING CLOUD UTILIZATION AND RECOMMENDING INSTANCE TYPE

(71) Applicant: HERE Global B.V., Eindhoven (NL)

(72) Inventor: Ali ABBAS, Hanau (DE)

(21) Appl. No.: 16/698,105

(22) Filed: Nov. 27, 2019

(51) Int. Cl. H04L 12/26; H04L 12/911; H04L 29/08

(52) U.S. Cl. CPC H04L 43/0876; H04L 67/10; H04L 47/82

(57) ABSTRACT

An approach is provided for estimating cloud utilization and recommending instance type. The approach involves receiving resource usage data for an instance of an application. The instance is executed on a cloud computing infrastructure, and the resource usage relates to one or more resources of the cloud computing infrastructure. The approach also involves processing the resource usage data to calculate average and maximum usage values of the resources of the instance. The approach further involves calculating an upper usage bound and a lower usage bound between which the instance is estimated to operate based on the average and maximum usage values of the resources. The approach further involves determining a recommended instance type for instantiating the application in the cloud computing infrastructure based on the upper usage bound and the lower usage bound. The approach further involves providing the recommended instance type as an output.

### BACKGROUND

Service providers are continually challenged to deliver value and convenience to consumers by, for example, providing compelling network services. To support such services, service providers often manage and process large data assets in the cloud for access by different consumers, businesses, and other entities. As the service providers constantly deploy and scale services, cloud spending grows quickly, and the service providers have to select the right instance types of different cloud service providers for different applications as well as to keep up with future instance type releases by the cloud service providers, in order to manage costs while ensuring performance. Some service providers hire quality assurance teams to profile the applications in relation to various instance types. Others simply estimate requirements and assume the cost forward. Accordingly, service providers face significant technical challenges to right-size their cloud computing infrastructure without deploying specific tracking systems or hiring expert profilers.

### SOME EXAMPLE EMBODIMENTS

Therefore, there is a need for an approach for estimating cloud utilization and recommending instance type.

According to one embodiment, a computer-implemented method comprises receiving resource usage data for an instance of an application. The instance is executed on a cloud computing infrastructure, and the resource usage relates to one or more resources of the cloud computing infrastructure. The method also comprises processing the resource usage data to calculate an average usage value and a maximum usage value of the one or more resources of the instance. The method further comprises calculating an upper usage bound and a lower usage bound between which the instance is estimated to operate based on the average usage value and the maximum usage value of the one or more resources. The method further comprises determining a recommended instance type for instantiating the application in the cloud computing infrastructure based on the upper usage bound and the lower usage bound. The method further comprises providing the recommended instance type as an output.

According to another embodiment, an apparatus comprises at least one processor, and at least one memory including computer program code for one or more computer programs, the at least one memory and the computer program code configured to, with the at least one processor, cause, at least in part, the apparatus to receive resource usage data for an instance of an application. The instance is executed on a cloud computing infrastructure, and the resource usage relates to one or more resources of the cloud computing infrastructure. The apparatus is also caused to process the resource usage data to calculate an average usage value and a maximum usage value of the one or more resources of the instance. The apparatus is further caused to calculate an upper usage bound and a lower usage bound between which the instance is estimated to operate based on the average usage value and the maximum usage value of the one or more resources. The apparatus is further caused to determine a recommended instance type for instantiating the application in the cloud computing infrastructure based on the upper usage bound and the lower usage bound. The apparatus is further caused to provide the recommended instance type as an output.

According to another embodiment, a non-transitory computer-readable storage medium carries one or more sequences of one or more instructions which, when executed by one or more processors, cause, at least in part, an apparatus to receive resource usage data for an instance of an application. The instance is executed on a cloud computing infrastructure, and the resource usage relates to one or more resources of the cloud computing infrastructure. The apparatus is also caused to process the resource usage data to calculate an average usage value and a maximum usage value of the one or more resources of the instance. The apparatus is further caused to calculate an upper usage bound and a lower usage bound between which the instance is estimated to operate based on the average usage value and the maximum usage value of the one or more resources. The apparatus is further caused to determine a recommended instance type for instantiating the application in the cloud computing infrastructure based on the upper usage bound and the lower usage bound. The apparatus is further caused to provide the recommended instance type as an output.

According to another embodiment, an apparatus comprises means for receiving resource usage data for an instance of an application. The instance is executed on a cloud computing infrastructure, and the resource usage relates to one or more resources of the cloud computing infrastructure. The apparatus also comprises means for processing the resource usage data to calculate an average usage value and a maximum usage value of the one or more resources of the instance. The apparatus further comprises means for calculating an upper usage bound and a lower usage bound between which the instance is estimated to operate based on the average usage value and the maximum usage value of the one or more resources. The apparatus further comprises means for determining a recommended instance type for instantiating the application in the cloud computing infrastructure based on the upper usage bound and the lower usage bound. The apparatus further comprises means for providing the recommended instance type as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of estimating cloud utilization and recommending instance type, according to one embodiment;

FIG. 2 is a diagram of the components of a resource management platform, according to one embodiment;

FIG. 3 is flowchart of a process for estimating cloud utilization and recommending instance type, according to one embodiment;

FIG. 4 is flowchart of a process for estimating cloud utilization, according to one embodiment;

FIG. 5A depicts the random utilization sample data along a timeline, according to one embodiment;

FIG. 5B depicts a lower usage bound of the random utilization sample data along a timeline, according to one embodiment;

FIG. 5C depicts an upper usage bound of the random utilization sample data along a timeline, according to one embodiment;

FIG. 5D is a histogram of the random utilization sample data, according to one embodiment;

FIG. 6A is flowchart of a process for building an unsupervised of instance offerings, according to one embodiment;

FIG. 6B is flowchart of a process for recommending instance type, according to one embodiment;

FIG. 7 is a diagram of an example user interface for presenting a recommended instance or right-scaling recommendation, according to one embodiment;

FIG. 8 is a diagram of a geographic database, according to one embodiment;

FIG. 9 is a diagram of hardware that can be used to implement an embodiment;

FIG. 10 is a diagram of a chip set that can be used to implement an embodiment; and

FIG. 11 is a diagram of a mobile terminal (e.g., handset or vehicle or part thereof) that can be used to implement an embodiment.

### DESCRIPTION OF SOME EMBODIMENTS

Examples of a method, apparatus, and computer program for estimating cloud utilization and recommending instance type according to one embodiment are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

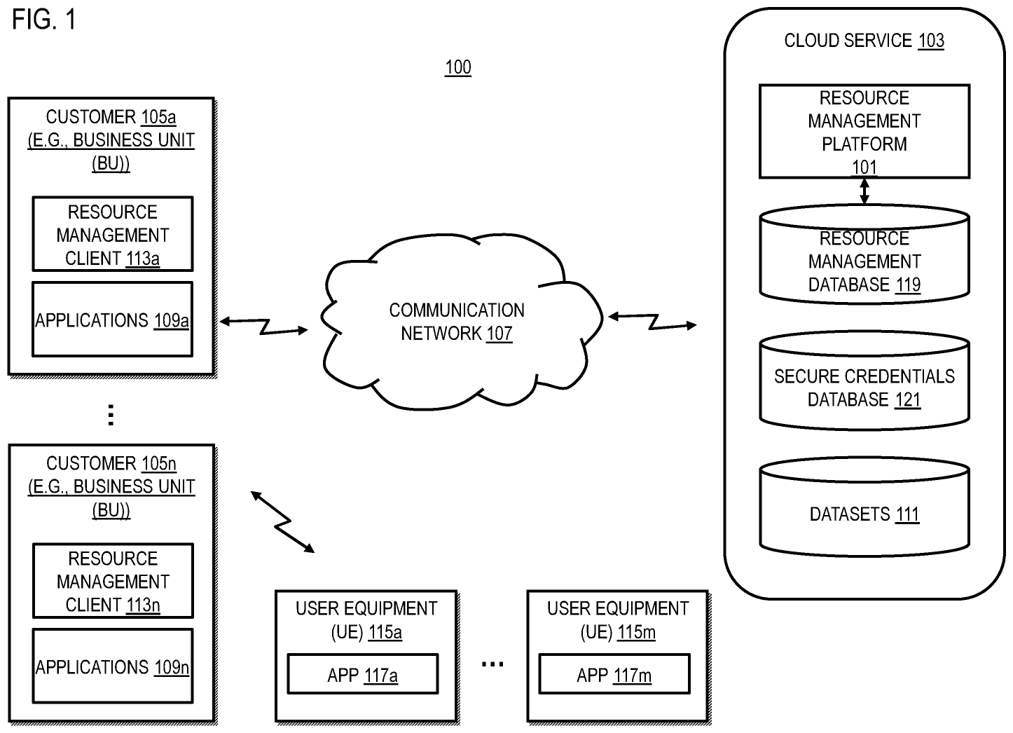

FIG. 1 is a diagram of a system capable of estimating cloud utilization and recommending instance type, according to one embodiment. Cloud Computing has revolutionized the way companies deploy and scale services and as such has subsequently accelerated the cloud computing market for small, medium and even larger companies. This effect has been more present in non-IT centric companies which do not usually have the inhouse personnel to assist in scaling a cloud computing infrastructure to support a new product launch or customer acquisition. Historically, the business model of most cloud computing providers is relatively simple: pay per instance per unit of time, the price per unit depends on the instance type. Instance types are generally organized as ratios of various computing resources such as but not limited to memory (e.g., RAM), processing resources (e.g., CPU), network bandwidth, disk input/output (I/O), and in some cases co-processing capabilities (e.g., graphics processing unit (GPU) capabilities). For example, the rise of Machine Learning applications has increased subsequent use of GPU or similar artificial intelligence (AI) dedicated co-processors in the cloud due to the large-scale compute requirement to train machine learning models. Companies that fully leverage the cloud have also the responsibility to select the right instance type as well as to keep up with future instance type releases in order to manage costs while ensuring performance. This is non-trivial as every application is different and every application under specific time constrain might exhibit different load behavior and requirements. To address this problem, some companies leverage an arsenal of performance and QA teams to profile the applications in relation to various instance types. Others simply make an estimate of requirements and assume the cost forward.

In other words, a cloud computing infrastructure generally offers the same capabilities as a local computing infrastructure (e.g., with components such as servers, network switches, memory, storage clusters, etc.) but with a lower cost, greater flexibility, and scalability. For example, cloud service providers have developed cloud-based platforms capable of handling vast collections of large databases that store, for instance, information, data, etc. generated by any number of services (e.g., both integrated and individual services). With an increasing demand for cloud services, cloud service providers provide infrastructure rightsizing recommendations for their customers in order to reduce costs, increase capacity, and avoid cannibalizing their own offerings and inventory. One existing approach measures average cloud resource utilization over a period of time (e.g., two weeks). Common cloud resources include CPU, memory, network bandwidth, etc. When the average CPU utilization is below a certain percentage, the existing approach recommends the customer to rightsize its infrastructure. In addition, the existing approach measures total bandwidth utilization over two weeks. When the total bandwidth utilization is below a certain amount, the existing approach recommends the customer to rightsize the infrastructure.

However, such average resource utilization data has a vanishing effect, such that peak resource utilization would never be reflected in the average resource utilization data. Taking a big data infrastructure as an extreme example, the computation happens occasionally while idling for most of the time. Additionally, the rightsizing recommendation model of such approach assumes a CPU metric as a reliable proxy of utilization. Nevertheless, most applications that are heavily I/O bounded (network or disk) tend to exhibit little CPU usage due to the underlying operating system optimization. Relying purely on CPU as an indicator generates a lot of false positive resource utilization data which lead to cloud resource availability issues and service-level agreement (SLA) breaches.

Another existing approach collects application metrics, calculates the 90th percentile of the histogram distribution for each metric, and uses this ceiling as a rightsizing mechanism. This approach compared to the first approach provides greater accuracy, yet it requires collecting every single datapoints (such as every 5 minutes, or event every 20 seconds per resource over weeks/months) in order to compute the precise ceiling. The downside of the second approach is the implied infrastructure requirements and overall complexity.

To address these problems, a system 100 of FIG. 1 introduces a capability that enables cloud service providers and consumers to continuously right-size their cloud compute infrastructure as the application evolves over time without the need to implement a specific tracking system nor hire expert profilers. In one embodiment, the system 100 provides a score system that rates each application from poor utilization to over utilization. This score can be used by providers and consumers to rightscale the infrastructure in order to improve performance and reduce costs. The scoring system uses some advance heuristic prediction to precisely estimate what the true usage of the infrastructure is without causing an availability issue. For example, the system can optimize across two main axes such as but not limited to (1) cost and (2) performance to identify the right or target ratio of balance.

In one embodiment, the system 100 also introduces a capability to build a machine learning model or other equivalent predictive engine that can recommend an instance type available in a cloud provider portfolio given system metric requirements. The recommendation can be generated with respect to any parameter including but not limited to cost (e.g., recommending a cheapest instance), performance (e.g., recommending a fastest instance), etc. More specifically, the system 100 can query the list of available instance types for a cloud provider and associated data (e.g., compute resource data, contextual data such as applicable region/location, etc.). This data can then be used to train the machine learning model (e.g., via unsupervised learning) to cluster the instances across cost per unit or other parameter to predict a recommended instance type from the available instance type of a cloud provider.

The embodiments of the system 100 provide technical solutions rightscaling cloud compute instances provide for several advantages including but not limited to:
The system 100 is not required to store or log all the metrics and datapoints of the target system.
The computation is extremely fast.
The system 100 does not require an organization to keep up with new instance type offerings or price changes from a cloud service provider. The machine learning model (e.g., discussed briefly above and in more detail below) handles this automatically.
The system 100 is not required to learn an application profile as it derives this individually by creating appropriate usage bounds according to embodiments described herein.
The system 100 reduces overall false positives and increases accuracy as it learns utilization behavior specific to the instance it is evaluating rather than applying some global measures as done by traditional cloud service providers.

As noted above, in one embodiment, the system 100 can generate a utilization efficiency score for a cloud application and recommend an instance type per application for a customer of a cloud service. This utilization efficiency score can be used by the cloud service provider and the customer to rightscale the infrastructure in order to improve application performance and reduce costs. In one embodiment, the system 100 leverages summary statistics (such as average and maximum resource utilization data) and heuristic prediction to estimate the usage of the infrastructure without incurring resource availability issues.

Generally, cloud service customers do not own the physical infrastructure, but rent the usage from a third-party provider. A common cloud pricing model is to charge per instance per unit of time. An instance, for instance, is a virtual server in a cloud infrastructure for running one or more applications on the cloud infrastructure. The price per unit is set per instance type. Instance types are organized as ratios of resources (such as RAM, CPU, network bandwidth, disk I/O, GPU, etc.). Different instance types are suitable for different applications, such as web and application servers, back-end servers for enterprise applications, gaming servers, batch processing, distributed analytics, high-performance computing, machine/deep learning inference, advertisement serving, highly scalable multiplayer gaming, and video encoding, high-performance databases, distributed in-memory caches, in-memory databases, big data analytics, high sequential I/O performance across very large data sets, machine learning, computational fluid dynamics, computational finance, seismic analysis, molecular modeling, genomics, and other high-performance computing workloads, etc. Entities leveraging the cloud need to select right instance types matching different applications to manage costs while ensuring performance. By way of example, the rise of machine learning applications increases GPU usage in the cloud due to large-scale computing requirements for training machine learning models. As a result, instance types for machine learning applications include more GPU or equivalent co-processing capabilities.

In one embodiment, the system 100 identifies an optimal balance of cost and performance via a resource management platform 101 for an application of a customer 105 of a cloud service 103. By way of example, the resource management platform 101 collects two utilization measurement metrics per each resource (e.g., CPU, memory, network, and bandwidth) for an application 109 of the customer 105 of the cloud service 103. Using these six metrics, the resource management platform 101 generates a statistical distribution that provides upper and lower usage bounds. The resource management platform 101 uses the two usage bounds to determine (1) a utilization efficiency score of how efficient the application 109 is operating on the cloud service 103, and (2) a target instance type for rightscaling. In this example, the system 100 neither suffers from the vanishing effect of simply using the resource utilization data as the first existing approach, nor relies or requires all utilization measurement datapoints as the second existing approach,

In one embodiment, one or more customers 105a-105n (also collectively referred to as customers 105) have access to the resource management platform 101 and the cloud service 103 over a communication network 107. In one embodiment, the customers 105a-105n respectively execute one or more resource management clients 113a-113n to interact with or perform all or a portion of the functions of the resource management platform 101. Descriptions of various embodiments of the functions of the resource management platform 101 and/or resource management client 113 are discussed in more detail below.

In one embodiment, the resource management platform 101 securely manages all of the datasets 111 collected from various customer applications 109a-109n (also collectively referred to as customer applications 113). For example, business units (BUs) of the customers 105 may manage the datasets 111 to support customer applications 109 (e.g., streaming media services, mapping services, social networking services, media sharing services, etc.) accessible by one or more user equipment (UEs) 115a-115m (also collectively referred to as UEs 115). In one embodiment, the UEs 115 may execute one or more applications 117a-117m (also collectively referred to as applications 117) to access the customer applications 109 and/or the datasets 111. By way of example, the applications 117 can be either native applications associated with the end-user facing applications 117 (e.g., client applications) or general applications (e.g., a browser application) that can access the customer applications 109 when implemented as a network-side application (e.g., a web application) or web page.

In one embodiment, the datasets 111 associated with customer applications 109 may raise user privacy concerns or have other potential sensitivities. Under such circumstances, the system 100 can encrypt the datasets 111 with keys controlled by the resource management clients 113 using various embodiments of the multi-layered security mechanisms described herein to protect the datasets against being accessed by unintended or unauthorized parties (e.g., external and/or internal parties).

In one embodiment, the resource management platform 101 and the system 100 uses secured communications protocols [e.g., a Secure Sockets Layer (SSL) protocol] as one layer of protection. For example, the resource management platform 101 can employ a two-way SSL authentication, where a customer 105 uses an SSL certificate for authentication authenticated (e.g., by the resource management platform 101, the cloud service 103, and/or another component of the system 100). In one embodiment, the secured credentials (e.g., the SSL certificates) are stored in the secure credentials database 121 of the cloud service 103.

In one embodiment, the cloud compute service can be delivered according to various models including but not limited to: IaaS (Infrastructure as a Service), Storage as a Service (STaaS), PaaS (Platform as a Service), Data as a Service (DaaS), Function as a Service (FaaS), and SaaS (Software as a Service). Each of the cloud models has their own set of benefits that could serve different business needs, and a few cloud service providers offer services including/integrating some or all of the service models to support analytics, computing, networking, database, storage, mobile and web applications. In one embodiment, the cloud service 103 includes one or more computation platforms capable of handling vast computation tasks on remote servers, such as deploying, managing, and maintaining virtual servers, PaaS, deploying applications, management support for docker containers, docker container registry, serverless compute, autoscaling, etc. Cloud computing services are on-demand, self-service, and involve broad network access, resource pooling, rapid elasticity, and measured services.

In one embodiment, the cloud service 103 includes one or more storage platforms (e.g., distributed storage platforms) capable of handling vast collections of large databases that store, for instance, information, data, etc. generated by any number of services (e.g., both integrated and individual services) of the business units (e.g., computing nodes, clusters, servers, etc.) of the customers 105. Many of these databases can reach multiple terabytes, petabytes, or more in size. In some cases, storage platforms can additionally split larger databases into smaller databases (e.g., partitions or database shards) maintained at multiple nodes to allow for the scalability and/or redundancy. By way of example, the storage platforms can include relational databases, key value stores, and/or other database structure.

In one embodiment, the cloud service 103 offers different customers 105 networks interconnecting with data centers using different products. By way of example, the cloud service 103 uses a virtual private cloud for networking and uses an API gateway for cross-premises connectivity. In another embodiment, the cloud service 103 supports customers 105 to deploy their own applications 109 on multiple servers virtually by using PaaS features, via deployment tools such as cloud services, container service, functions, batch, app services, etc. In another embodiment, the cloud service 103 provides customers 105 an ability to implement a database (e.g., implemented in SQL or equivalent solutions).

In one embodiment, the resource management database 119 includes cloud service offer data from one or more cloud service providers. This cloud service offer data contains, e.g., data or descriptions on available instance types, the respective CPU, memory, storage, network requirements, and pricing data, etc. In another embodiment, the resource management database 119 includes metadata reference tables/matrixes that indicate how an application behaves in the cloud over a period of time, such as 24 hours, one week, two weeks, etc. By way of example, the metadata reference tables/matrixes include utilization measurement data of various cloud compute resources such as central processing units (CPUs), memory, bandwidth, graphics processing units (GPUs), co-processors, etc.

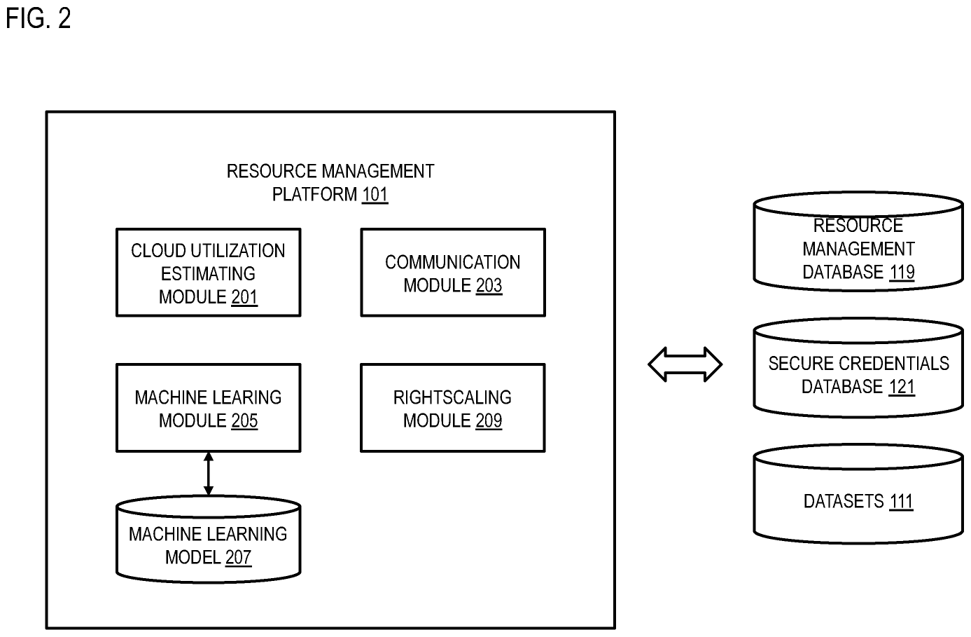

FIG. 2 is a diagram of the components of a resource management platform, according to one embodiment. By way of example, the resource management platform 101 (network-side component) and the resource management client 113 (client-side component) include one or more components for estimating cloud utilization and recommending instance type. It is contemplated that the functions of these components may be combined in one or more components or performed by other components of equivalent functionality. In one embodiment, the resource management platform 101 includes a cloud utilization estimating module 201, a communication module 203, a machine learning module 205, a trained machine learning model 207, and a rightscaling module 209. In one embodiment, the resource management platform 101 and/or its components have connectivity to the resource management database 119, the secure credentials database 121, and the datasets 111.

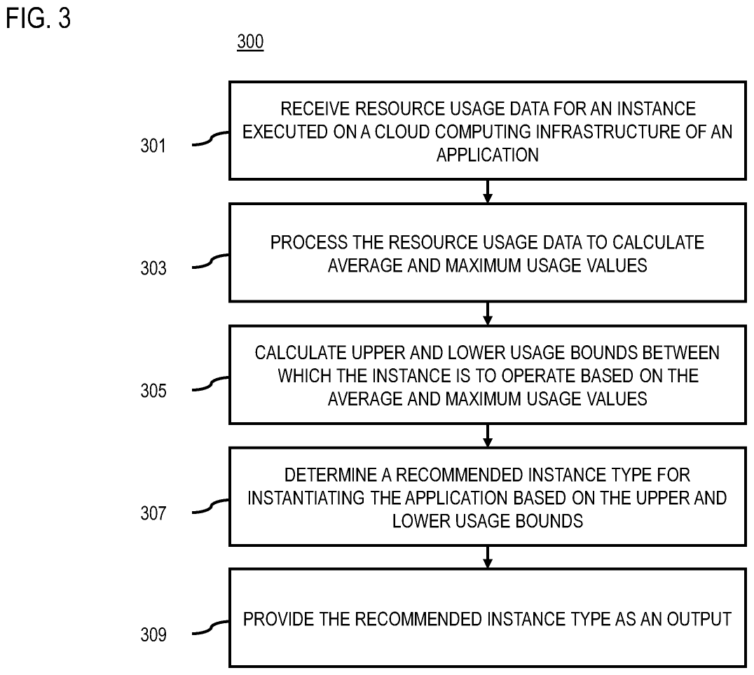

The above presented modules and components of the resource management platform 101 can be implemented in hardware, firmware, software, or a combination thereof. Though depicted as separate entities in FIG. 1, it is contemplated that the resource management platform 101 may be implemented as a module of any of the components of the system 100. In another embodiment, the resource management platform 101 and/or one or more of the modules 201-209 may be implemented as a cloud-based service, local service, native application, or combination thereof. The functions of the resource management platform 101 and/or the modules 201-209 are discussed with respect to FIGS. 3-7 below.

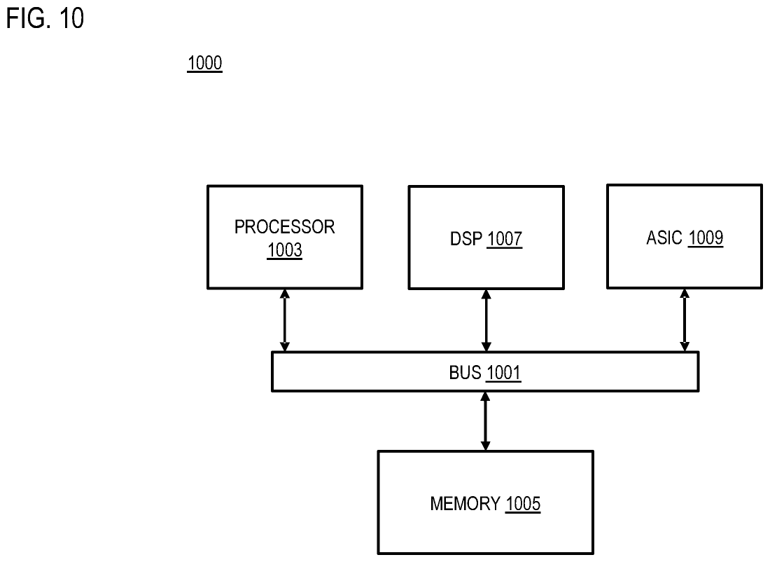

Various embodiments of the components of the resource management platform 101 are described with respect to FIG. 3. FIG. 3 is flowchart of a process for estimating cloud utilization and recommending instance type, according to one embodiment. In one embodiment, the resource management platform 101 performs the process 300 and is implemented in, for instance, a chip set including a processor and a memory as shown in FIG. 10. In addition or alternatively, the resource management client 113 can perform all or a portion of the process 300.

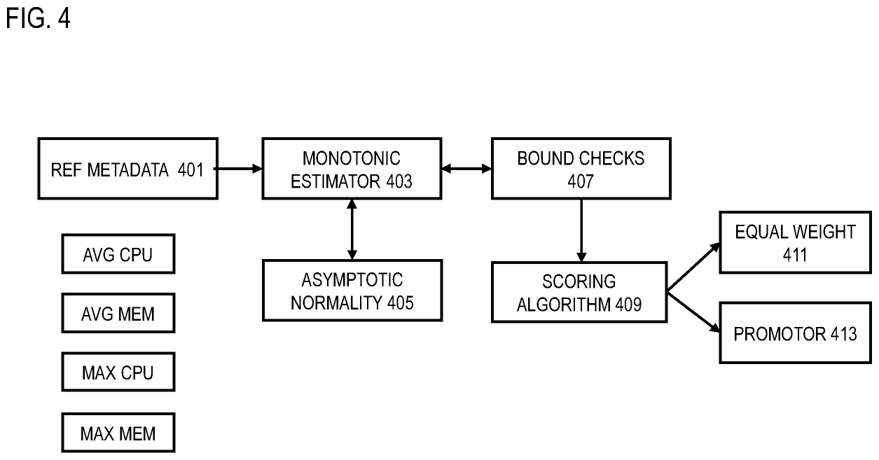

Referring back to the example of using utilization measurement metrics per each resource (e.g., CPU, memory, network, and bandwidth) for the application 109, the resource management platform 101 generates a statistical distribution that provides upper and lower usage bounds using a detailed example of the process 300 is described with respect to FIGS. 4-7 below.

In step 301, the cloud utilization estimating module 201 receives resource usage data for an instance of an application via the communication module 203. The instance is executed on a cloud computing infrastructure (e.g., of the cloud service 103), and the resource usage relates to one or more resources of the cloud computing infrastructure. For examples, the one or more resources include a central processing unit (CPU), a memory, a bandwidth, a graphics processing unit (GPU), a co-processor, or combination thereof.

FIG. 4 is flowchart of a process for estimating cloud utilization, according to one embodiment. In step 303, the cloud utilization estimating module 201 processes the resource usage data (e.g., reference metadata 401) to calculate an average usage value and a maximum usage value of the one or more resources utilized of the instance (e.g., Ave_CPU, Ave_Mem, Max_CPU, Max_Mem, etc.). In one embodiment, monotonic estimator 403 of the cloud utilization estimating module 201 extracts two-week average and maximum utilization data of resources of an instance for the application 109 as well the number of hours which the instance has been running. By way of example, the monotonic estimator 403 estimates utilization per each resource (e.g., a CPU, a memory, a bandwidth), and determines how often the maximum utilization of that resource was hit. Therefore, the cloud utilization estimating module 201 uses a small sets of datapoints. (instead of thousands of datapoints as the existing approaches) to estimate the true resource utilization of the instance by the application 109. By way of example, the monotonic estimator 403 calculates CPU utilization {avg: 10%, max: 50%}, memory utilization {avg: 5, max: 30}, bandwidth {total: 10030}, and instance utilization hours {total: 12}. In this example, the application 109 started, and shut down from time to time such that the application 109 only ran 12 hours during the two weeks. The cloud utilization estimating module 201 extracts the current total amount of CPU and Memory assigned to the instance: assigned_cpu->{total: 16}, and assigned_memory->{total: 32}.

In step 305, the monotonic estimator 403 calculates an upper usage bound and a lower usage bound between which the instance is estimated to operate based on the average usage value and the maximum usage value of the one or more resources.

In one embodiment, the monotonic estimator 403 calculates the lower and upper bound for the CPU and memory using the same method of determining a maximum usage value, a maximum usage percentage, an average usage value, and a maximum usage value. For CPU, the monotonic estimator 403 sets a minimum CPU usage value (cpu_mn) as 0, and a maximum CPU value (cpu_mx) as the total assigned CPU number of the instance (e.g., assigned_cpu=16) as depicted in Table 1. In addition, the monotonic estimator 403 sets a maximum CPU usage percentage (cpu_mxu) as a maximum CPU usage percentage during the two weeks (e.g., 99%), and an average CPU usage value (cpu_mean_std) as an average of all sample CPU number datapoints during the two weeks (e.g., 8.17 CPU). Thereafter, the monotonic estimator 403 sets a maximum CPU usage value (cpu_mean_upd) as cpu_mxu*cpu_mx (e.g., 99%*16=15.85), and a runtime as the total utilization hours (utilization_hours=12).

TABLE 1

▪ cpu_mn = 0
▪ cpu_mx = assigned_cpu−>total
▪ cpu_mxu = cpu−>max
▪ cpu_mean_std = cpu−>avg * cpu_mx
▪ cpu_mean_upd = cpu_mxu * cpu_mx
▪ runtime = utilization_hours−>total

In this instance, the minimum CPU usage value cpu_mn is set as 0, although in reality the minimum CPU usage value may be 0.01-0.02 CPU. In another instance, the minimum CPU usage value is set as 1 CPU.

In one embodiment, the upper usage bound and the lower usage bound are calculated using a statistical distribution of the average value and the maximum usage value of the one or more resources, based on asymptotic normality 405. By way of example, the statistical distribution is a triangular distribution. Unlike normal/Gaussian distributions (e.g., steadily increase CPU utilization 0.5% every 5 min), cloud usages behave more like a series of triangular distributions each of which is a continuous probability distribution with lower limit a, upper limit b and mode c, where a<b and a≤c≤b. By way of example, a navigation application offered by a map service provider has map-download peaks during traffic hours and evening dead periods across different time zones. In other embodiments, different distributions are applied to different frequency-based usage behaviors to estimate the resource utilization (e.g., fleet management (e.g., airplanes, buses, taxis, etc.), planning new roads/runways/terminals/bus stops, lane adjustment on a road, open-air concert/theater seats/parking spaces, etc.) without taking all available datapoints.

In one embodiment, the monotonic estimator 403 calculates an estimated resource usage mode of the one or more resources based on the average usage value and the maximum usage value. The estimated resource usage mode is a most frequent resource usage value (e.g., peak) of the one or more resources occurring in the resource usage data for the instance, and the triangular distribution uses the estimated resource usage mode as a further input.

According to Table 2, the monotonic estimator 403 computes three types of modes and do the average by shifting the mode/peak with respect to time. In one embodiment, to find out how the utilization behaved, the monotonic estimator 403 assumes three mode distributions/patterns, shifts the mode/peak from left, to middle, to right, and then averages the three mode distributions/patterns. The rationale behind this approach is that by knowing the average and the max, the system 101 can create an estimated utilization distribution close to the true utilization distribution by shifting the position of the max value in relation to the average.

TABLE 2
▪ mode_1 = 3* average − min − max
▪ mode_2 = (3 * mean − max) / 2
▪ mode_3 = (3 * mean − min) / 2
▪ mode = AVERAGE(mode_1, mode_2, mode_3)
▪ tri = TRIANGULAR_DISTRIBUTION (min, mode, max, runtime)
▪ upper_bnd = PERCENTILE(tri, U%) / cpu_mx
▪ lower_bnd = PERCENTILE(tri, L%) / cpu_mx
▪ cpu_score = 0 if cpu_mx is within lower_bnd and upper_bnd
▪ cpu_score = −1 if cpu_mx is below the lower_bnd
▪ cpu_score = 1 if cpu_mx is above upper_bnd

In other embodiments, the system 101 weights one mode more than the other modes based on its knowledge of the operation of instance for the application 109 (e.g., peak traffic hours for the navigation application as discussed), instead of averaging the three modes.

In one embodiment, the monotonic estimator 403 generates estimated utilization distribution values twice: the first time using the average usage value to generate a lower usage bound (cpu_lobnd), and the second time using the maximum usage value to generate a upper usage bound (cpu_upbnd). By way of example, the monotonic estimator 403 calculates a Triangular Distribution tri=TRIANGULAR_DISTRIBUTION (min, mode, max, runtime). The monotonic estimator 403 further calculates the lower and upper bounds via a Bound Checking Algorithm 407: upper_bnd=PERCENTILE (tri, U %)/cpu_mx, and lower_bnd=PERCENTILE (tri, L %)/cpu_mx.

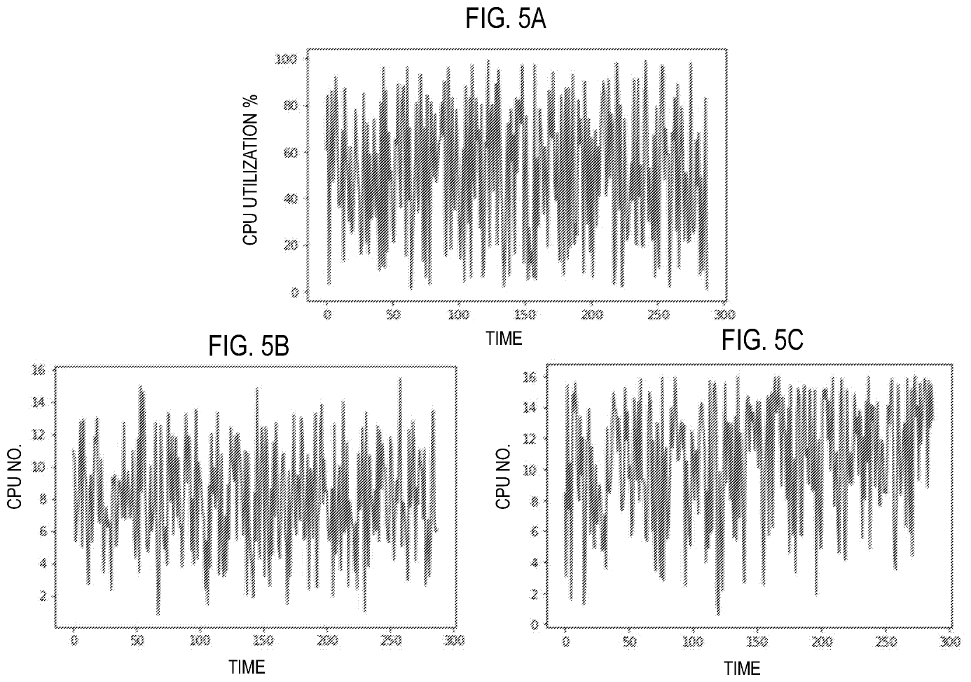

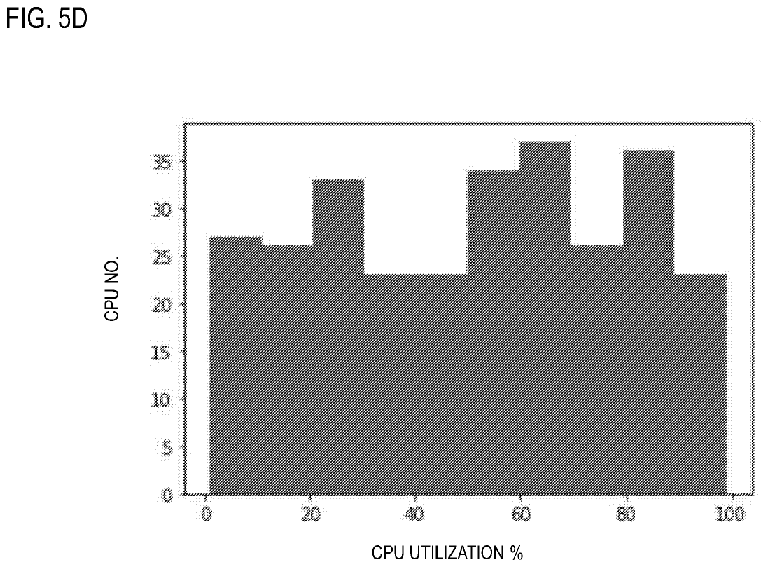

A percentile is a measure used in statistics indicating the value below which a given percentage of observations in a group of observations falls. As later shown in FIG. 5D, the 70th percentile is the value below which 70% of the observations may be found. In one embodiment, the U and L percentiles are chosen to not to create negative count numbers which are impractical to use. In another embodiment, the U and L percentiles are chosen depending how aggressive the system 100 can leave the instance idle without breaching a service contact for the application 109. Some service providers set 70% of CPU, some others set 50% of CPU is sufficient. By way of example, the system 101 can operate 70-80% of CPU.

Once the mode is calculated for a resource, the monotonic estimator 403 can normalize the mode with a bias. Example of bias: if mode <0:mode=0, if mn>mode:mn=mode, if mode >mx:mode=mx. In one embodiment, missing data points cause a mode to be negative, the monotonic estimator 403 normalizes the mode based on historical data, such as adding 0.01 CPU, adding bandwidth, etc.

In one embodiment, the Bound Checks Algorithm 407 calculates a resource usage efficiency score of the instance based on the upper usage bound and the lower usage bound (e.g. using a Scoring Algorithm 409), and provides the resource usage efficiency score as an output. With these two bounds that provide a range where the application mostly should reside in terms of performance, the Bound Checks Algorithm 407 evaluates where the application currently sits. By way of example, the resource usage efficiency score (e.g., cpu_score) is 0, when the maximum usage value of the resource (e.g., cpu_mx) is within the lower and upper usage bounds. The resource usage efficiency score is −1, when the maximum usage value of the resource is below the lower usage bound. The resource usage efficiency score is 1, when the maximum usage value of the resource is above the upper usage bound.

As a simulation, the system 100 generates random utilization sample data (between percentage 1-100) taken for one day as Table 3. FIG. 5A depicts the random utilization sample data along a timeline, according to one embodiment. In this example, the 288 datapoints of various utilization percentages are taken every 5 minutes for 24 hours and then plotted along a timeline on the x axis. In this dataset, the average CPU utilization is 51%, the maximum CPU utilization is 99%, and the running time is 288.

TABLE 3
61 84 3 51 86 47 68 92 76 38 36 41 69 13 87 58 50 30 62 25 27 51 78 57
47 39 16 22 85 54 21 72 16 59 31 42 74 32 59 34 9 81 11 96 10 86 17 68
48 52 25 21 65 63 89 51 36 81 88 66 15 96 39 70 1 23 39 57 81 34 41 93
73 13 70 6 84 52 3 81 63 49 76 47 55 64 65 81 67 90 15 32 96 68 18 83
43 35 78 58 33 14 34 61 4 88 59 29 83 6 97 49 40 83 65 69 27 80 6 13
64 62 99 19 76 80 43 74 89 20 95 68 44 23 2 22 57 72 7 78 56 67 16 83
51 82 80 72 97 12 53 75 5 27 12 17 6 97 5 57 28 78 69 59 33 62 50 19
86 69 66 94 47 39 68 33 13 84 54 7 79 87 14 87 19 54 93 20 29 24 82 63
74 57 8 90 62 29 74 17 66 6 58 69 28 62 41 69 82 90 84 41 49 91 49 76
71 3 10 98 89 35 80 2 24 74 38 22 26 43 55 39 91 29 20 91 41 54 20 19
84 99 66 30 53 34 22 67 6 79 27 10 73 97 96 48 70 59 59 2 29 68 65 83
26 89 10 53 79 59 22 51 48 21 22 98 30 25 28 65 45 68 7 49 9 36 83 1

FIG. 5B depicts a lower usage bound of the random utilization sample data along a timeline, according to one embodiment. FIG. 5C depicts an upper usage bound of the random utilization sample data along a timeline, according to one embodiment. In FIGS. 5B-5C, 100% of CPU capabilities equal to a total number of 16 CPUs, and the patterns of the lower and upper usage bounds (cpu_lobnd, cpu_upbnd) closely match the pattern of the original CPU utilization data in FIG. 5A.

FIG. 5D is a histogram of the random utilization sample data, according to one embodiment. The histogram is a representation of the distribution of the random utilization sample data in Table 1 in ten ranges. Taller bars show that more utilization sample data fall in the respective range. In FIG. 5D, the ten ranges are divided among the utilization percentage values of 1.0, 10.8, 20.6, 30.4, 40.2, 50.0, 59.8, 69.6, 79.4, 89.2, and 99, with the respective counts of 27, 26, 33, 23, 23, 34, 37, 26, 36, 23. FIG. 5D shows that the application uses 20-30%, 50-70%, and 80-90% of the CPU 40% of the day. Therefore, the system 101 suggests the best CPU utilization percentage range for the application is roughly between 70-80%, as estimated only based on the average CPU number, the maximum CPU number, and the running time. Since the application used 80-90% of the CPU capabilities only 10% of the day (i.e., how often hitting the maximum CPU number), while using 50-70% of the CPU capabilities 20% of the day (i.e., more often hitting the 50-70% CPU capabilities). If the CPU utilization hits the maximum CPU number only once, the resources are under-utilized, and if the CPU utilization hits the maximum CPU number more than 50% of the time, the resources may need to be right-scaled to avoid potential outage issues. The recommend operation range can shift base on input data and the application.

The Bound Checks Algorithm 407 repeats the same process for memory to calculate a lower usage bound (mem_lobnd), an upper usage bound (mem_upbnd), and a memory usage efficiency score (e.g., mem_score). The Scoring Algorithm 409 then evaluates whether the bandwidth is within 10% of 1 Gbps for the runtime. By way of example, if it is within 10% of 1 Gbps, the Scoring Algorithm 409 sets the bwd_score as 1. If it is not within 10% of 1 Gbps, the Scoring Algorithm 409 sets the bwd_score as 0. The bwd_scores are not fixed, but depending on how conservative the system and/or the user intend to deploy the Scoring Algorithm 409.

In one embodiment, the scoring algorithm 409 gives the three scores equal weight 411, such that the Scoring Algorithm 409 calculates a total score based the three scores as follow: total_score=bwd_score+cpu_score+mem_score. In another embodiment, the scoring algorithm 409 uses a promotor 413 to give the three scores different weight, such that the Scoring Algorithm 409 calculates a total score based Table 4.

TABLE 4

ref_score = cpu_score + mem_score
toal_score = penalize (ref_score, bwd_score)

The CPU score and the memory score are used as for penalization, but the bandwidth score comes in as a bonus. In one embodiment, the monotonic estimator 403 determines an input/output value of the one or more resources based on the resource usage data. For example, the input/output value relates to a bandwidth usage, a disk transfer usage, a co-processor usage, or a combination thereof. When bandwidth is used a lot, such as 1 GB per second, the monotonic estimator 403 can add more resources to support the application 109, e.g., plus one to the total score, to be conservative and reduce false positive utilization measurement and not to be too strict. In other words, the monotonic estimator 403 can adjust the total score at the end. Other adjustment/bias factors may include bandwidth, I/O disks, etc., depending on the instance and the application 109.

The monotonic estimator 403 then determines whether the instance should be rightscaled based on the total score. When the instance should be rightscaled, the rightscaling module 209 calculates what is the true CPU and Memory counts required as Table 5:

TABLE 5

∘ new_cpu_number = cpu_mx * cpu_lobnd
∘ new_memory_number = memory_mx * memory_lobnd

Due to the complicated instance type scheme with each pre-package instance type comes with fixed CPU number (e.g., 16), memory, network bandwidth, etc. It is difficult to select the instance type manually. In one embodiment, the resource management platform 101 initiates a rightscaling of the instance based on the resource usage efficiency score. By way of example, the rightscaling includes: determining a true resource usage value for the one or more resources based on the average usage value, the maximum usage value, the upper usage bound, the lower usage bound, or a combination thereof. The resource management platform 101 then processes the true resource usage value using the trained machine learning model 207 to determine the recommended instance type. In step 307, the rightscaling module 209 determines a recommended instance type for instantiating the application in the cloud computing infrastructure based on the upper usage bound and the lower usage bound.

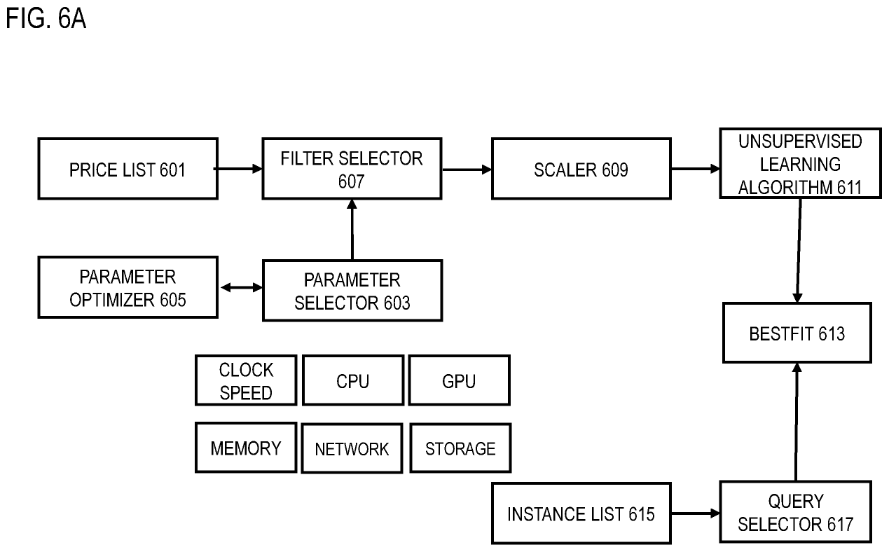

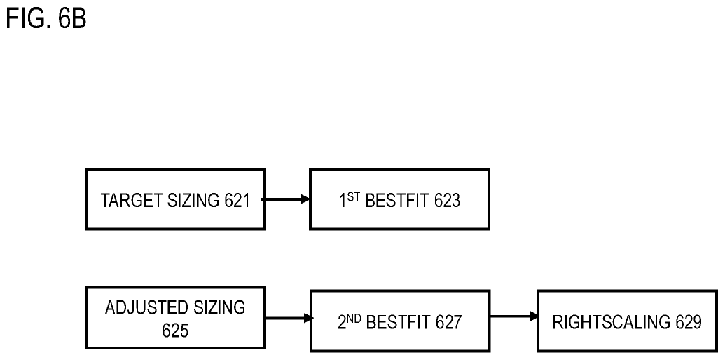

FIG. 6A is flowchart of a process for building an unsupervised machine learning model of instance offerings, according to one embodiment. The machine learning module 205 retrieves a price list 601 contains all the instance types, their respective clock speeds, CPU, GPU, memory, storage, network bandwidth requirements and additional data such as the region, etc. The machine learning module 205 includes a resource parameter selector 603, a resource parameter optimizer 605, a filter selector 607, a scaler 609, an unsupervised machine learning algorithm 611, an unsupervised machine learning model (“BestFit”) 613, a query selector 617, and an instance list 615. The above presented modules and components of the resource management platform 101 can be implemented in hardware, firmware, software, or a combination thereof. Though depicted as separate entities in FIG. 1, it is contemplated that the machine learning module 205 may be implemented as a module of any of the components of the resource management platform 101. In another embodiment, the machine learning module 205 and/or one or more of the modules 601-617 may be implemented as a cloud-based service, local service, native application, or combination thereof.

In one embodiment, the machine learning module 205 downloads price and resource configuration matrix (numbers and models of CPU, AMD or Intel, Verizon, etc.) of instances based on instance categories of the cloud service provider.

In another embodiment, the resource parameter selector 603 interacts with the resource parameter optimizer 605, to select all applicable resources (e.g., CPU, memory, network bandwidth, etc.) for the application 109. The filter selector 607 then filters away any resources that may create conflicts or issues based on criteria stored in the system 100. The scaler 609 then scales the operating parameters of the remaining resources.

In one embodiment, the machine learning module 205 creates the trained machine learning model 207 as the unsupervised machine learning model 613 (e.g., a 10 size cluster), using the unsupervised machine learning algorithm 611 (e.g., K-means clustering, hierarchical clustering, etc.) on the remaining resources. The unsupervised machine learning model 611 includes quarriable clusters (i.e., an instance type list 615) that optimize across cost per unit and the resource utilization measurements. By way of example, the cloud service provider offers ten memory-optimizing instances; however, Bestfit 613 organizes its own instance type list 615, not following the cloud service provider's instance types. The machine learning module 205 saves and stores the unsupervised machine learning model 613 and the instance type list 615 for later query by the query selector 617.

FIG. 6B is flowchart of a process for recommending instance type, according to one embodiment. In one embodiment, the unsupervised machine learning model 613 can make recommendations across CPU Architecture by analyzing the clock speed of the various offerings. By way of example, the rightscaling module 209 or the query selector 617 uses the new_cpu_number and new_memory_number, to query the unsupervised machine learning model 613 for resource parameter values of a target sizing 621 to be normalized to standard offerings by the cloud service provider. The unsupervised machine learning model 613 or the query selector 617 returns the first match to these resource parameter values, via 1^{st} BestFit 623. The rightscaling module 209 or the query selector 617 uses these new resource parameter values to query the unsupervised machine learning model 613 again (via 2^{nd} BestFit 627) for the most appropriate instance to match a lower cost per unit (i.e., an adjusted sizing 625). For example, the first recommended CPU and memory counts (“target sizing”) are in floating numbers, such as 2.3 CPU, 4.81 GB, etc. The next BestFit as the 2^{nd} recommendation a closest and cheapest instance type, and/or a better version number of the instance type. The last returned value is the suggested instance type for rightscaling 629. In step 309, the rightscaling module 209 or the query selector 617 provides the recommended instance type as an output.

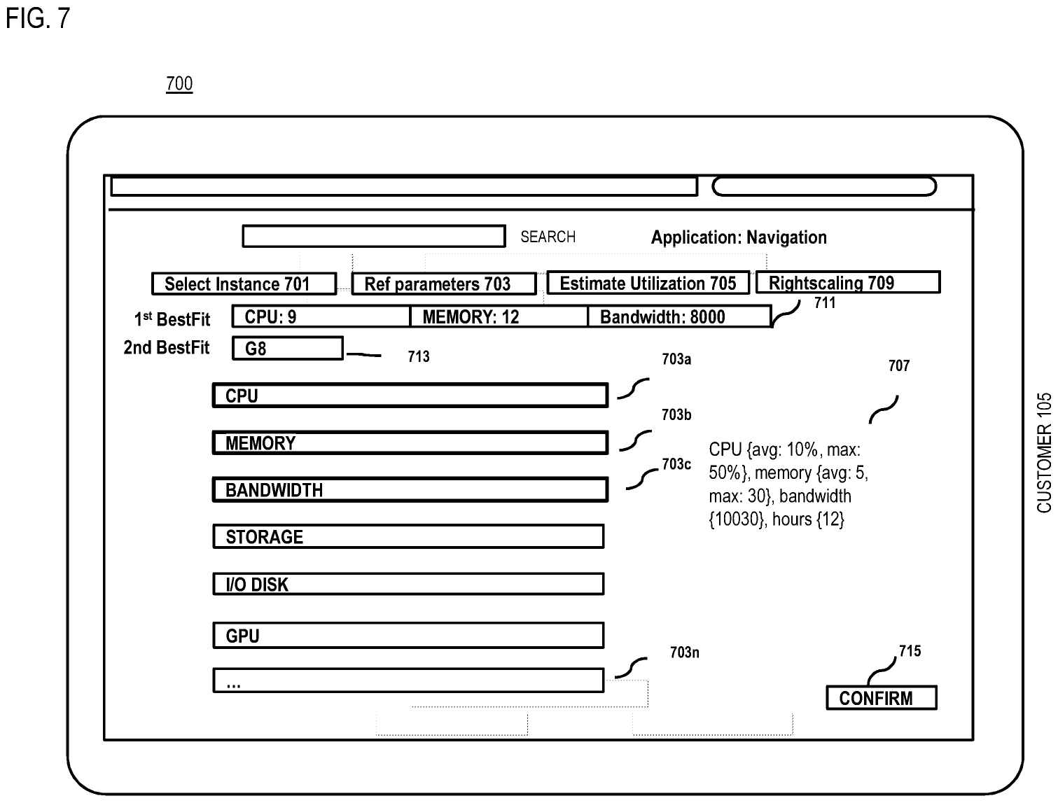

FIG. 7 is a diagram of an example user interface for presenting right-scaling recommendation and/or a recommended instance, according to one embodiment. For example, in the user interface (UI) 700 of FIG. 7, the user types “Navigation” in an application block, and then clicks a “Select Instance” button 701. After the user clicks a “Reference parameters” button 703, the system 100 highlights three resources: CPU 703a, Memory 703b, and Bandwidth 703c in a resource list. After the user clicks a “Estimate Utilization” button 705, the system 100 uses the process of FIG. 3 to estimate the respective resource utilization, and displays the estimated results in a box 707 as follows: CPU {avg: 10%, max: 50%}, memory {avg: 5, max: 30}, bandwidth {10030}, and hours {12}. After the user clicks a “Rightscaling” button 709, the system 100 executes 1^{st} BestFit and displays optimal resource parameter values 711: CPU 9, Memory: 12, Bandwidth: 8000. The system 100 then executes 2nd BestFit and recommends an optimal instance: G8 in a box 713. After the user clicks a “Confirm” button 715, the system 100 scale downs to the instance G8.

The system 100 can recommend a new instance type in a predetermined frequency (i.e., how often to optimize the application environment), based on web loop changes (e.g., weather, traffic, etc.), predicted future demands, etc., to modify instance on the fly.

The above-described embodiments can be applied to resources on a device as on a cloud computing infrastructure.

The processes described herein for estimating cloud utilization and recommending instance type may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

Returning to FIG. 1, in one embodiment, the UEs 115 can be associated with any user using services (e.g., navigation services) offered by one or more service providers via one or more cloud infrastructure. By way of example, the UEs 115 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that a UE 115 can support any type of interface to the user (such as “wearable” circuitry, etc.). In one embodiment, the vehicles 115 may have cellular or wireless fidelity (Wi-Fi) connection either through the inbuilt communication equipment or from a UE 115 associated with the vehicles 115. Also, the UEs 115 may be configured to access the communication network 107 by way of any known or still developing communication protocols.

In one embodiment, the UEs 115 include device sensors (e.g., a front facing camera, a rear facing camera, GPS sensors, multi-axial accelerometers, height sensors, tilt sensors, moisture sensors, pressure sensors, wireless network sensors, etc.) and applications 117 (e.g., mapping applications, ride hailing booking or reservation applications, routing applications, guidance applications, navigation applications, etc.). In one example embodiment, the GPS sensors can enable the UEs 115 to obtain geographic coordinates from satellites for determining current or live location and time (e.g., within a POI). Further, a user location within a POI may be determined by a triangulation system such as A-GPS, Cell of Origin, or other location extrapolation technologies when cellular or network signals are available. In one embodiment, the location of the UEs 115 can be determined within a POI based on one or more WiFi routers positioned throughout the POI.

In one embodiment, the resource management platform 101 performs the process for estimating cloud utilization and recommending instance type as discussed with respect to the various embodiments described herein. In one embodiment, the resource management platform 101 can be a standalone server or a component of another device with connectivity to the communication network 107. For example, the component can be part of an edge computing network where remote computing devices (not shown) are installed along or within proximity of an intended destination (e.g., a city center).

In one embodiment, the resource management platform 101 has connectivity over the communication network 107 to the customers 105 that provides one or more services (e.g., mapping/routing services). By way of example, the services offered by the customers 105 may include mapping services, navigation services, ride hailing reservation or booking services, guidance services, notification services, social networking services, content (e.g., audio, video, images, etc.) provisioning services, application services, storage services, contextual information determination services, location-based services, information-based services (e.g., weather, news, etc.), etc. In one instance, the services offered by the customers 105 provide representations of each user (e.g., a profile), his/her social links, and a variety of additional information (e.g., one or more physical attributes). In one instance, the services offered by the customers 105 can allow users to share location information, activities information, POI related information, contextual information, and interests within their individual networks, and provides for data portability.

In another embodiment, the customers 105 may provide content or data (e.g., navigation-based content such as destination information, routing instructions, estimated times of arrival, POI related data such as indoor maps and entry-exit points, historical human traffic data; ride hailing service booking or contact information; etc.) to the UEs 115, the applications 117, the resource management platform 101, the secure credentials database 121, and the services offered by the customers 105. The content provided may be any type of content, such as map content, contextual content, audio content, video content, image content (e.g., exterior images of a POI), etc. In one embodiment, the customers 105 may also store content associated with the UEs 115, the applications 117, the resource management platform 101, the secure credentials database 121, and/or the services offered by the customers 105. In another embodiment, the customers 105 may manage access to a central repository of data, and offer a consistent, standard interface to data, such as a repository of the secure credentials database 121.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the resource management platform 101 may be a platform with multiple interconnected components. By way of example, the resource management platform 101 may include multiple servers, intelligent networking devices, computing devices, components and corresponding software for estimating cloud utilization and recommending instance type. In addition, it is noted that the resource management platform 101 may be a separate entity of the system 100, the customers 105, or a part of the services offered by the customers 105.

By way of example, the UEs 115, the applications 117, the resource management platform 101, the secure credentials database 121, and the customer business units communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the components of the system 100 may interact according to a client-server model. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

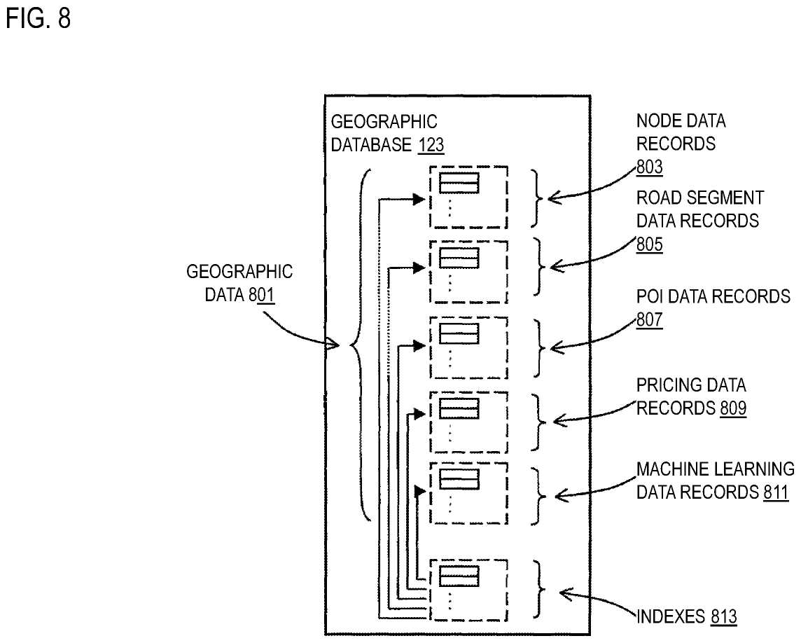

FIG. 8 is a diagram of a geographic database 123, according to one embodiment. In one embodiment, the geographic database 123 is stored in the cloud as a part of the datasets 111 to support customer applications 109. The geographic database 123 includes geographic data 801 used for (or configured to be compiled to be used for) mapping, navigation-related services and/or autonomous driving services, such as for generating driving instructions based on mapped features, e.g., lane lines, road markings, signs, etc.

In one embodiment, the geographic database 123 stores information regarding indoor map information, historic human traffic data, or a combination thereof associated with a POI. In one instance, the geographic database 123 also stores information regarding one or more physical attributes, average walking data (e.g., a mobility graph), or a combination thereof of a user of a user device (e.g., a mobile phone, a smartphone, a pair of smart glasses, etc.). In one embodiment, the geographic database 123 stores data associated with vehicular traffic proximate to a POI, ride hailing service booking and/or contact information, etc. The information may be any of multiple types of information that can provide means for estimating cloud utilization and recommending instance type. In another embodiment, the geographic database 123 may be in a cloud and/or in a UE 115, or a combination thereof.

In one embodiment, geographic features, e.g., two-dimensional or three-dimensional features, are represented using polygons, e.g., two-dimensional features, or polygon extrusions, e.g., three-dimensional features. For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in geographic database 123.

“Node”—A point that terminates a link.

“Line segment”—A straight line connecting two points.

“Link” (or “edge”)—A contiguous, non-branching string of one or more-line segments terminating in a node at each end.

“Shape point”—A point along a link between two nodes, e.g., used to alter a shape of the link without defining new nodes.

“Oriented link”—A link that has a starting node (referred to as the “reference node”) and an ending node (referred to as the “non-reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary, e.g., a hole or island. In one embodiment, a polygon is constructed from one outer simple polygon and none or at least one inner simple polygon. A polygon is simple if it just consists of one simple polygon, or complex if it has at least one inner simple polygon.

In one embodiment, the geographic database 123 follows certain conventions. For example, links do not cross themselves and do not cross each other except at a node. Also, there are no duplicated shape points, nodes, or links. Two links that connect each other have a common node. In geographic database 123, overlapping geographic features are represented by overlapping polygons. When polygons overlap, the boundary of one polygon crosses the boundary of the other polygon. In geographic database 123, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 123 includes node data records 803, road segment or link data records 805, POI data records 807, cloud service pricing data records 809, machine learning model data records 811, and indexes 813, for example. More, fewer or different data records can be provided. In one embodiment, additional data records (not shown) can include cartographic (“carto”) data records, routing data, and maneuver data. In one instance, the additional data records (not shown) can include user mobility pattern data. In one embodiment, the indexes 813 may improve the speed of data retrieval operations in geographic database 123. In one embodiment, the indexes 813 may be used to quickly locate data without having to search every row in geographic database 123 every time it is accessed. For example, in one embodiment, the indexes 813 can be a spatial index of the polygon points associated with stored feature polygons.

In exemplary embodiments, the road segment data records 805 are links or segments representing roads, streets, or paths, as can be used in the calculated route or recorded route information for determination of one or more personalized routes, an estimated time of arrival, or a combination thereof (e.g., an estimated time of arrival of a ride hailing vehicle 115 at a POI pickup point). The node data records 803 are end points corresponding to the respective links or segments of the road segment data records 805. The road link data records 805 and the node data records 803 represent a road network, such as used by vehicles, cars, and/or other entities. Alternatively, the geographic database 123 can contain path segment and node data records or other data that represent pedestrian paths, bicycle paths, or areas in addition to or instead of the vehicle road record data, for example.

The road/link segments and nodes can be associated with attributes, such as functional class, a road elevation, a speed category, a presence or absence of road features, geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 123 can include data about the POIs and their respective locations in the POI data records 807. In one instance, the POI data records 807 can include indoor map information, entry-exit point information (e.g., numbers and locations of entry-exit points), historic pedestrian traffic flows within the POI, historic vehicular traffic flows proximate to the POI, opening and closing times of a POI, etc.

In one embodiment, the indoor map information is created from high-resolution 3D mesh or point-cloud data generated, for instance, from LiDAR. The 3D mesh or point-cloud data are processed to create 3D representations of interior pathways, hallways, corridors, etc. of a POI at centimeter-level accuracy for storage in the POI data records 807.

In one embodiment, the geographic database 123 can also include cloud service pricing data records 809. By way of example, the cloud service pricing data records 809 may include a correlation table/matrix among resource feature parameters versus all pricing and virtual and/or physical attributes. Such correlation table/matrix can be constructed for a group of customers, or tailored for a specific customer.

In one embodiment, the geographic database 123 can also include machine learning model data records 811. In another embodiment, the machine learning model data records 811 stores information relating to the one or more machine learning algorithms, one or more instance type lists, one or more machine learning models for recommending instance types, etc. By way of example, the machine learning model data records 811 can be associated with one or more of the node data records 803, road segment data records 805, and/or POI data records 807 to support estimating cloud utilization and recommending instance type.

In one embodiment, geographic database 123 can be maintained by a content provider in association with the services offered by the customers 105, e.g., a map developer. The map developer can collect geographic data to generate and enhance geographic database 123. There can be different ways used by the map developer to collect data. These ways can include obtaining data from other sources, such as municipalities or respective geographic authorities. In addition, the map developer can employ field personnel to travel by foot with a UE 115 within various large POIs to determine step counting information or records about them, for example. Also, remote sensing, such as aerial or satellite photography, can be used for approximating interior distances (e.g., using one or more satellites).

The geographic database 123 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, a UE 115, for example. The navigation-related functions can correspond to pedestrian navigation, vehicle navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for estimating cloud utilization and recommending instance type may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

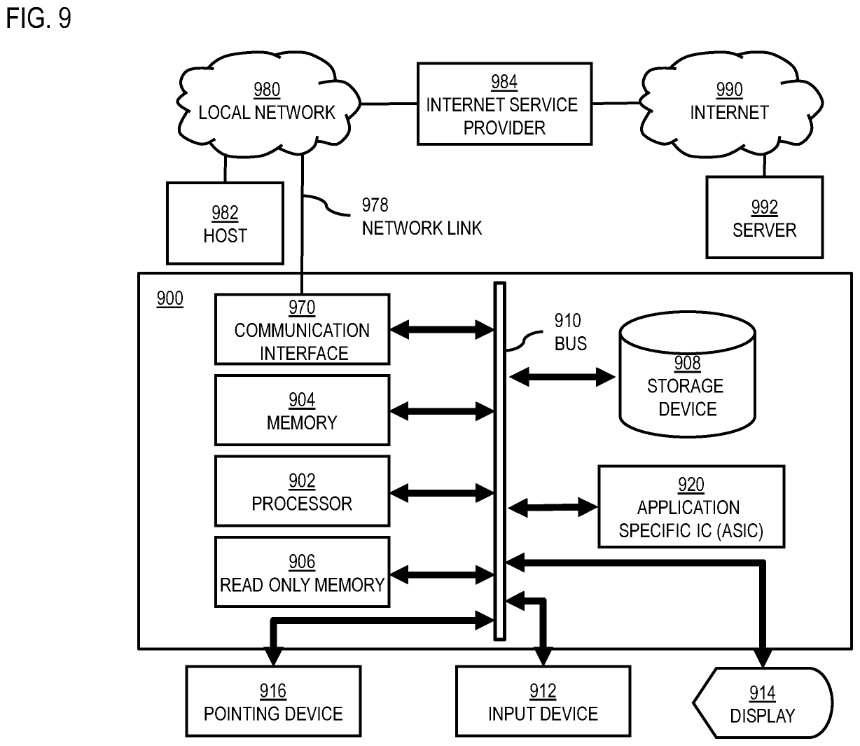

FIG. 9 illustrates a computer system 900 upon which an embodiment of the invention may be implemented. Computer system 900 is programmed (e.g., via computer program code or instructions) to estimate cloud utilization and recommend instance type as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to estimate cloud utilization and recommend instance type. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for estimating cloud utilization and recommending instance type. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for estimating cloud utilization and recommending instance type, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for estimating cloud utilization and recommending instance type to the UE 115.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system can be deployed in various configurations within other computer systems, e.g., host 982 and server 992.

FIG. 10 illustrates a chip set 1000 upon which an embodiment of the invention may be implemented. Chip set 1000 is programmed to estimate cloud utilization and recommend instance type as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to estimate cloud utilization and recommend instance type. The memory 1005 also stores the data associated with or generated by the execution of the inventive steps.

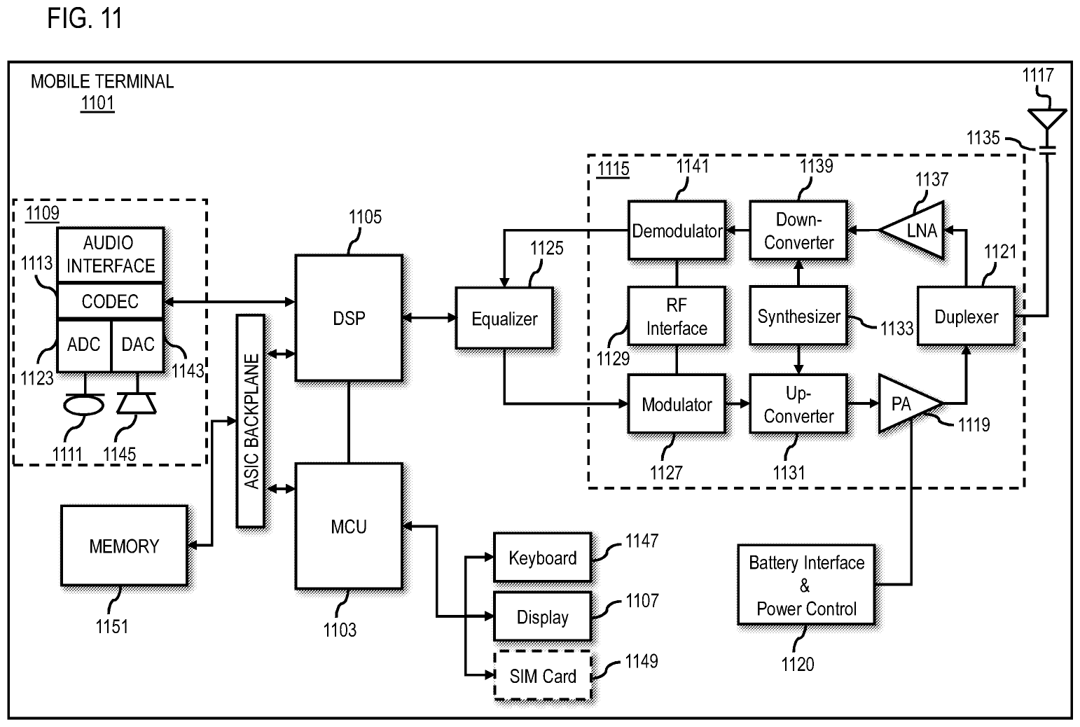

FIG. 11 is a diagram of exemplary components of a mobile terminal 1101 (e.g., a UE 115 or component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 to estimate cloud utilization and recommend instance type. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1151 may be, but not limited to, a single memory, CD, DVD, ROM, RAM, EEPROM, optical storage, or any other non-volatile or non-transitory storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving resource usage data for an instance of an application, wherein the instance is executed on a cloud computing infrastructure, and wherein the resource usage relates to a plurality of resources of the cloud computing infrastructure;
processing the resource usage data to calculate an average usage value and a maximum usage value of the plurality of resources by the instance;
calculating an upper usage bound and a lower usage bound between which the instance is estimated to operate based on the average usage value and the maximum usage value of the plurality of resources;
determining a recommended instance type for instantiating the application in the cloud computing infrastructure based on the upper usage bound and the lower usage bound; and
providing the recommended instance type as an output.

2. The method of claim 1, wherein the upper usage bound and the lower usage bound are calculated using a statistical distribution of the average value and the maximum usage value of the plurality of resources.

3. The method of claim 2, wherein the statistical distribution is a triangular distribution.

4. The method of claim 3, further comprising:
calculating an estimated resource usage mode of the plurality of resources based on the average usage value and the maximum usage value,
wherein the estimated resource usage mode is a most frequent resource usage value of the plurality of resources occurring in the resource usage data for the instance, and
wherein the triangular distribution uses the estimated resource usage mode as a further input.

5. The method of claim 1, further comprising:
calculating a resource usage efficiency score of the instance based on the upper usage bound and the lower usage bound; and
providing the resource usage efficiency score as another output.

6. The method of claim 5, further comprising:
initiating a rightscaling of the instance based on the resource usage efficiency score.

7. The method of claim 6, wherein the rightscaling comprises:
determining a true resource usage value for the one or more resources based on the average usage value, the maximum usage value, the upper usage bound, the lower usage bound, or a combination thereof.

8. The method of claim 7, further comprising:
processing the true resource usage value using a trained machine learning model to determine the recommended instance type.

9. The method of claim 1, further comprising:
determining an input/output value of the plurality of resources based on the resource usage data; and
biasing the resource usage efficiency score based on the input/output value.

10. The method of claim 9, wherein the input/output value relates to a bandwidth usage, a disk transfer usage, a co-processor usage, or a combination thereof.

11. The method of claim 1, wherein the plurality of resources include a central processing unit (CPU), a memory, a bandwidth, a graphics processing unit (GPU), a co-processor, or combination thereof.

12. An apparatus comprising:
at least one processor; and
at least one memory including computer program code for one or more programs,
the at least one memory and the computer program code configured to, with the at least one processor, cause the apparatus to perform at least the following,
receive resource usage data for an instance of an application, wherein the instance is executed on a cloud computing infrastructure, and wherein the resource usage relates to a plurality of resources of the cloud computing infrastructure;
process the resource usage data to calculate an average usage value and a maximum usage value of the plurality of resources by the instance;
calculate an upper usage bound and a lower usage bound between which the instance is estimated to operate based on the average usage value and the maximum usage value of the plurality of resources;
calculate a resource usage efficiency score of the instance based on the upper usage bound and the lower usage bound; and
provide the resource usage efficiency score as an output.

13. The apparatus of claim 12, wherein the apparatus is further caused to:
initiate a rightscaling of the instance based on the resource usage efficiency score.

14. The apparatus of claim 13, wherein the rightscaling further caused the apparatus to:
determine a true resource usage value for the plurality of resources based on the average usage value, the maximum usage value, the upper usage bound, the lower usage bound, or a combination thereof.

15. The apparatus of claim 12, wherein the apparatus is further caused to:
determine a recommended instance type for instantiating the application in the cloud computing infrastructure based on the upper usage bound and the lower usage bound; and
providing the recommended instance type as another output.

16. The apparatus of claim 12, wherein the upper usage bound and the lower usage bound are calculated using a statistical distribution of the average value and the maximum usage value of the plurality of resources.

17. A non-transitory computer-readable storage medium carrying one or more sequences of one or more instructions which, when executed by one or more processors, cause an apparatus to at least perform the following steps:
receiving resource usage data for an instance of an application, wherein the instance is executed on a device, and wherein the resource usage relates to a plurality of resources of the device;
processing the resource usage data to calculate an average usage value and a maximum usage value of the plurality of resources by the instance;
calculating an upper usage bound and a lower usage bound between which the instance is estimated to operate based on the average usage value and the maximum usage value of the plurality of resources;
determining a recommended instance type for instantiating the application in the device based on the upper usage bound and the lower usage bound; and
providing the recommended instance type as an output.

18. The non-transitory computer-readable storage medium of claim 17, wherein the upper usage bound and the lower usage bound are calculated using a statistical distribution of the average value and the maximum usage value of the plurality of resources.

19. The non-transitory computer-readable storage medium of claim 18, wherein the apparatus is caused to further perform:
calculating an estimated resource usage mode of the plurality of resources based on the average usage value and the maximum usage value,
wherein the estimated resource usage mode is a most frequent resource usage value of the plurality of resources occurring in the resource usage data for the instance; and
wherein the triangular distribution uses the estimated resource usage mode as a further input.

20. The non-transitory computer-readable storage medium of claim 17, wherein the apparatus is caused to further perform:
calculating a resource usage efficiency score of the instance based on the upper usage bound and the lower usage bound; and
providing the resource usage efficiency as another output.
